(19) United States
(12) Patent Application Publication
(10) Pub. No.: US 2012/0295209 A1
(43) Pub. Date: Nov. 22, 2012

(54) METHOD FOR HEATING COATED GLASS SHEETS IN AN OVEN

(75) Inventors: David Pierre, Jumet (BE); Ronny Pieters, Jumet (BE); Jean-Marie Sellier, Jumet (BE)

(73) Assignee: AGC GLASS EUROPE, Bruxelles (Watermael-Boitsfort) (BE)

(21) Appl. No.: 13/521,897

(22) PCT Filed: Feb. 1, 2011
(86) PCT No.: PCT/EP2011/051362

§ 371 Date: Jul. 12, 2012

(30) Foreign Application Priority Data
Feb. 3, 2010 (BE) BE2010/0058

(51) Int. Cl. F27D 3/00

(52) U.S. Cl. 432/11

(57) ABSTRACT

The present invention relates to a method for heating glass sheets having an organic material-based coating in an oven, particularly with a view to the subsequent tempering thereof. More precisely, the invention relates to a method enabling glass sheets having an organic material-based coating to be heat treated by enabling the management of the rapid and violent combustion of said organic material in the oven, using a forced heat convection effect due to a hot gas comprising an oxidizer, injected above the glass sheet at least between t1 and t2, t1 being the time at which the flames from the combustion of the organic matter appear and t2 the time when said flames disappear.

### 1. FIELD OF THE INVENTION

The present invention relates to a method for heating glass sheets in an oven, in particular with a view to the subsequent toughening thereof. More precisely, the invention relates to a method for heating glass sheets having a decorative coating such as one of organic material based paint.

### 2. SOLUTIONS OF THE PRIOR ART

Glass sheets having a painted type of decorative coating have various applications. For example, they can be used as partitions, tables, shelves or wall covering (interior or exterior). These applications increasingly require toughened glass sheets for safety reasons, since such a toughened glass has an increased shock resistance. One of the known methods of toughening glass is “thermal toughening” (very rapid cooling) that firstly requires the glass sheet to be heated in an oven at temperatures in the order of 560°-750° C.

Widely known ovens for heating glass sheets with a view to their subsequent toughening comprise a generally ceramic-coated roller conveyor, above and below which electrical resistors are arranged for heating by radiation glass sheets transported on said conveyor. The whole arrangement is located in an insulating chamber. During heating of the resistors the rollers of the conveyor store heat and rapidly transfer it back to the glass they come into contact with by conduction. With equal heating power of the lower and upper resistors the lower face of a glass sheet accordingly receives a greater quantity of heat per unit time than the upper face. This can cause a concave sagging of such a glass sheet in relation to the plane of the conveyor, which possibly leads to a deterioration in the flatness thereof as well as surface faults due to a concentration of weight of the glass sheet on a reduced portion of the surface of the rollers. An uneven heating of the glass sheets can also cause optical distortions in the glass and affect the uniformity of their fragmentation when they are fractured once toughened. This circumstance is further accentuated when the glass sheets heated in the oven are coated with low-emissivity (low-e) layers that have the property of reflecting a significant portion of the heat radiated by the resistors. These layers are inorganic in type, based on metals, oxides and/or nitride. A well known example is the layer stack ZnSnOx/Ag/ZnSnOx. The face coated with the low-e layer is generally the one that does not come into contact with the rollers of the conveyor, so that these do not cause any damage to the coating of these sheets by mechanical contact. Consequently a substantial portion of the heat radiated by the upper resistors does not heat the upper face of the sheets. In the prior art it has been proposed to remedy the phenomena of sagging of the glass sheet by balancing the temperature profile of the glass sheets conveyed in the oven. For this purpose it is possible, especially in accordance with the instructions of patent U.S. Pat. No. 4,390,359, to provide in the heating oven in particular a mean for injecting hot as above the upper face of the glass sheets conveyed in this oven. A transfer of heat by forced convection occurs between the gas jets and the upper face of the sheets. It is necessary in this case to interrupt the injection of gas during the heating cycle when the temperature of the glass has increased sufficiently, otherwise a convex bending of the sheets can occur. Control of the precise moment when it is necessary to limit the supply of heat by forced convection to the upper face of the glass sheets is sensitive and it has therefore been proposed to arrange, in addition to the mean for injecting hot gas above the upper face, a mean for injecting hot gas below the conveyor perpendicularly (EP 058 529 A1) or obliquely (EP 1 377 529 B1) in relation to the glass sheets (double convection oven). Such a mean allows the total thermal output applied to the upper and lower faces of a glass sheet to be balanced, thus eliminating the phenomenon of bending and restoring the flatness of the glass sheets.

In practice, the injection of hot gas below the conveyor is not actuated from entry of the sheet into the oven: the lower face of said sheet is firstly only heated by the heat radiated by the resistors arranged below the conveyor while the upper face is heated by the heat radiated by forced convection by means of hot gas jets located below the conveyor and directed towards said face. When the thermal balance of the heat supplied to each face of the sheet becomes unfavourable at its lower face and the sheet consequently bends convexly above the conveyor, the injection of hot gas directed towards the lower face of the sheet is then actuated.

This is illustrated schematically by FIG. 1, which corresponds to a representation relating to the pressure of hot gas injected above (upper pressure) and below (lower pressure) a non-coated glass sheet (a) and a glass sheet coated with a low-e layer (b) heated in an oven: the injection of hot gas above the glass sheet is actuated from entry of the glass sheet into the oven and is maintained for a large portion of the total heating time T, whereas the injection of hot gas below the glass sheet is only actuated when the thermal balance of the heat supplied to each face of the sheet becomes unfavourable at the lower face and the glass consequently bends. This circumstance occurs most often towards the end of the heating cycle, e.g. at around 80% of the total heating time T. Also most frequently the injection of hot gas above the glass sheet is stopped when the injection of hot gas below the glass sheet is actuated. Moreover, for the reasons outlined above, the pressure of hot as above the glass sheet must be significantly higher in the case of glass sheet coated with a low-e layer (phenomenon of accentuated bending) in relation to a non-coated glass sheet.

The solutions of the prior art have all been developed from the viewpoint of restoring the flatness of the glass sheets heated in an oven, whether this concerns non-coated glass sheets (without a layer) or glass sheets coated with an inorganic layer with special low-e properties. In these two cases the glass as well as the possible layer do not undergo any significant chemical modification because of the thermal treatment in the oven.

In the particular case of thermal treatment with a view to a subsequent toughening of a glass sheet having a decorative coating such as one of an enamel-based paint of organic material, as described in the application WO2007/104752A1, for example, undesirable phenomena occur as a result of the presence of the organic material. In fact, at a temperature that often reaches 700° C. in the oven this organic material undergoes an intense thermal degradation and more particularly a rapid and intense combustion (because of the presence of air in the oven). Such a combustion supplies large quantities of heat and often generates combustion flames. When the decorative coating covering the glass sheet contains a not insignificant quantity of organic material (from about 10% by mass), the transformation of the organic material into combustion as in the heating oven is thus accompanied by flames that originate on the surface of the glass sheet and that can sometimes reach a significant height in the order of some tens of centimetres. These flames pose serious disadvantages and are therefore undesirable because:

they cause a reduction in quality of the finished product after toughening. In fact, once toughened the coating exhibits a poor surface uniformity as a result of too intense a combustion that was not evenly distributed over the surface of the sheet and thus presents a very poor aesthetic appearance (marks, black deposits, uneven colour . . . );

they damage the heating oven because of the proximity of some elements (thermocouples, electrical resistors, as injectors . . . ) of the oven in relation to the conveyed glass sheets, and this is all the more significant because of their size.

### 3. OBJECTIVES OF THE INVENTION

In particular the aim of the invention is to remedy these aforementioned disadvantages by solving the technical problem, i.e. the rapid and intense combustion that is very often accompanied by flames during the heating of glass sheets having an organic material-based coating in an oven, in particular with a view to their subsequent toughening.

More precisely, the aim of the invention in at least one of its embodiments is to provide a method for heating glass sheets having an organic material-based coating in an oven that allows a final toughened product to be obtained that is visually uniform and that has the desired aesthetic appearance.

Another aim of the invention is to provide a method for heating glass sheets having an organic material-based coating in an oven that allows the heating tool to be preserved.

Finally, a last aim of the invention is to provide a solution to the disadvantages of the prior art that is simple and economical.

### 4. OUTLINE OF THE INVENTION

In accordance with a particular embodiment, the invention relates to a method for heating glass sheets having an organic material-based coating in an oven, wherein (i) said glass sheets are transported by a roller conveyor, (ii) the faces of a glass sheet are heated for a time T by means for heating by radiation arranged above and below said sheet and wherein (iii) at a given instant and for a given period of time said faces are subjected to a forced heat convection effect by injecting a hot gas above and below said glass sheets.

According to the method of the invention the injection of hot gas above the glass sheet is actuated at least during the combustion of said organic material of the coating. In particular, the hot as is injected above the glass sheet at least between t1 and t2, wherein t1 is the instant when the flames coming from the combustion of the organic material appear and t2 is the instant when said flames disappear. Combustion is understood to be the oxido-reduction reaction between a fuel and an combustive: the fuel, which in the present case is the organic material, oxidises because of an oxidising combustive such as the oxygen present in the ambient air of the oven. The combustion generates (i) heat and (ii) combustion products, most frequently gaseous products such as CO₂, CO and H₂O. When the combustion products can no longer be oxidised, i.e. they can no longer react with the combustive, combustion is considered to be complete.

Hence, the invention is based on a completely novel and inventive approach, since it enables glass sheets having an organic material-based coating to be thermally treated by managing the combustion of the organic material present in significant quantity by means of a particular control different from that known in the prior art to thermally treat non-coated glass or glass coated with an inorganic type of coating. In particular, the injection of the hot gas above the glass sheet at least during the combustion of the organic material of the coating, and in particular at least between t1 and t2, has the function of creating a more uniform, and therefore improved, combustion over the entire surface of the glass. Moreover, the flux of as allows, on the one hand, (i) the flames to be blown and their size to be reduced considerably until they are eliminated.

Still according to the method of the invention, the hot gas that is injected above the glass sheet contains at least one combustive, which then supplements the oxygen of the air present in the ambient air of the oven. Thus, the combustion process is improved because of the additional supply of combustive, which further promotes a uniform aesthetic result for the final toughened product. Combustive is understood to be any compound that will be reduced during the combustion reaction and will thus allow oxidation of the fuel.

On the other hand, in accordance with the invention the injection of hot gas above the glass sheet can also be actuated outside the period of the combustion process and in particular outside the time when flames are present (therefore outside the time range t1-t2). In this particular case, the injection of hot gas above the glass sheet will have an additional classic function of maintaining or restoring the flatness of the sheet.

According to a first advantageous embodiment or variant of the invention, the minimum pressure of the hot gas injected above the glass sheet is 5 mbar. This minimum pressure allows a good additional supply of combustive and enables the combustion process, and in particular its uniformity, to be improved significantly.

According to another advantageous embodiment or variant of the invention, the maximum pressure of the hot gas injected above the glass sheet is 15 bar. As a result of this maximum value a thermal shock to the glass sheet that could occur because of an excessive supply of heat in a short period of time can be prevented.

The combustion generated by the presence of organic material in the coating causes additional heating of the upper face of the glass sheet because of the exothermicity of the combustion reaction. Consequently, according to the invention and in a known manner, the injection of a hot gas below said sheet directed towards its lower face allows a thermal balance to be restored between each of the faces of the sheet and bending thereof and the resulting undesirable consequences for the final product to thus be limited or prevented. According to the invention, the injection of a hot gas below the glass sheet is actuated when the glass sheet bends convexly above the conveyor. The advantages of injecting a hot gas below the glass sheet are therefore the same as those of the prior art, i.e. to maintain flatness of the glass sheet, and consequently will not be explained in more detail.

### 5. LIST OF FIGURES

Other features and advantages of the invention will become clearer on reading the following description of a preferred embodiment given by way of illustrative and non-restrictive example and the attached figures, wherein:

FIG. 1, in accordance with the prior art, is a schematic representation relating to the pressure of hot gas injected above (upper pressure) and below (lower pressure) a non-coated glass sheet (a) and a glass sheet coated with a low-e layer (b) heated in an oven for a total time period T;

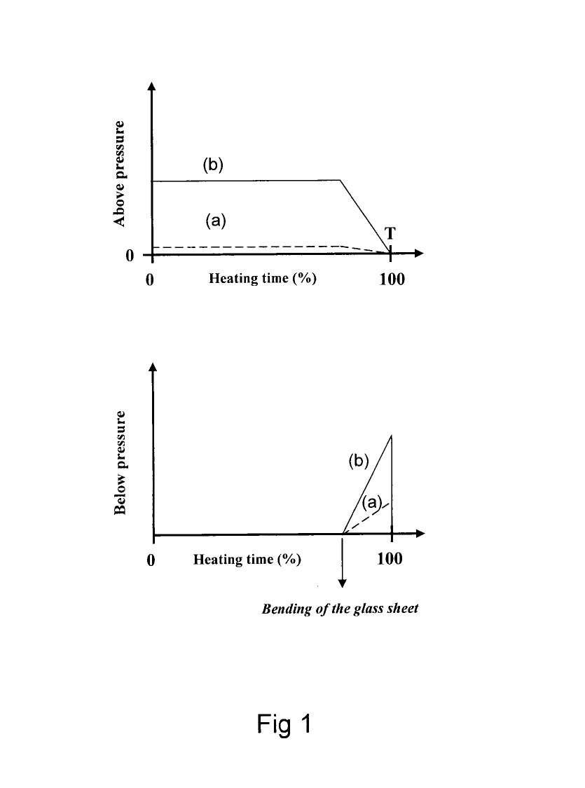

FIG. 2, in accordance with three embodiments of the invention (pressure profiles 1, 2 and 3), is a schematic representation relating to the pressure of hot gas injected above (upper pressure) a glass sheet having an organic material-based coating and heated in an oven for a total time period T.

### 6. DESCRIPTION OF AN EMBODIMENT OF THE INVENTION

The organic material-based coating according to the invention is, for example, a paint-type decorative coating. “Paint-type coating” is understood to be in particular one or more layers of paint, lacquer, varnish or enamel. These coatings often contain a significant quantity (from about 10% by mass and up to 90% by mass) of various organic components such as, typically, binders (polymers), hardeners (oligomers), plasticisers and other additives.

According to the invention, the glass sheets are transported through the oven by a roller conveyor, wherein the rollers are preferably substantially horizontal.

Examples of the means for heating by radiation according to the invention are typically electrical resistors or equivalent means.

The hot gas can be injected into the chamber of the oven in the direction of the glass sheet, whether above or below said sheets, by injectors connected to hot gas supply means such as a supply ramp arranged above or below the conveyor and themselves connected to at least one compressor.

It is preferred that the means for supplying hot gas to the injectors arranged below the conveyor are controlled separately from the means for supplying hot as to the injectors arranged above the conveyor, e.g. by means of valves for opening and dosing these.

The injection of hot gas in the form of jets can occur perpendicularly to the glass sheets, as described in patent U.S. Pat. No. 4,390,359, or alternatively obliquely in the direction of the sheet, as described in patent EP 1 377 529 B1.

The hot gas injected into the oven can be reheated from the ambient temperature upon its entry in the supply means for the injectors, during its passage through these means up to the injectors, wherein said means are themselves heated by the electrical resistors arranged in the oven. Alternatively, the gas can be preheated outside the oven before being fed into the supply means for the injectors. The hot gas is preferably injected above the glass sheet at a temperature higher than 400° C.

According to the invention, the hot gas injected above the glass sheet contains at least one combustive. It is preferred that the combustive is oxygen. It is particularly preferred, because it is economical, that the hot gas injected above the glass sheet is air.

The hot gas injected above the glass sheet can be identical in composition to the hot as injected below the glass sheet. Alternatively, these two gases can be of different compositions.

Moreover, the temperature of the hot as injected above the glass sheet can be identical or different to that of the hot as injected below the glass sheet.

According to the invention, the hot as is injected above the glass sheet at least between t₁ and t₂, wherein t₁ is the instant when the flames coming from the combustion of the organic material appear and t₂ is the instant when said flames disappear.

Measurements of glass sheets having an organic material-based coating using thermogravimetric analysis in air reveal that the combustion thereof generally starts when the glass and the coating have reached a temperature of about 250° C. The flames resulting from said combustion thus appear as soon as the glass and the coating have reached at least this temperature. The flames generally appear when the temperature reaches the “auto-ignition point”, which is the temperature from which a gas or a vapour spontaneously ignites in the absence of a pilot flame or spark. The time t₁ corresponding to the instant when the flames coming from the combustion of the organic material appear can, of course, vary as a function of the temperature in the oven chamber, of the thickness of the glass etc.

According to a particularly preferred embodiment of the invention, the pressure of the hot gas injected above the glass sheet passes through a maximum between t₁ and t₂, including the times t₁ and t₂. The maximum pressure value can occur at t₁, t₂, t₁ and t₂, or also within the temperature range t₁-t₂.

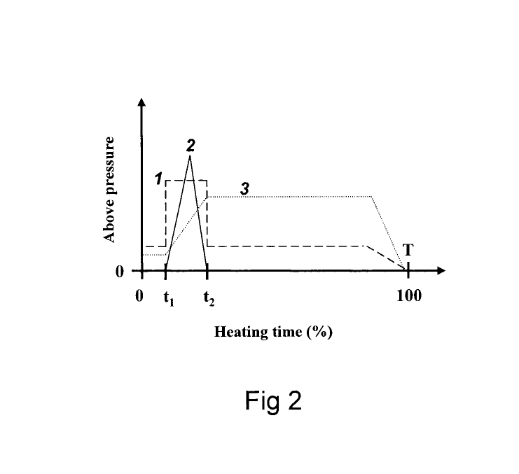

Such a feature allows a further improvement in the combustion of the organic material and also allows a more effective blowing of the flames. By way of example, FIG. 2 illustrates in a schematic and relative manner three pressure profiles 1, 2 and 3 of the hot as injected above the glass sheet (upper pressure) according to this embodiment of the invention.

According to an embodiment of the invention illustrated in profile 1 of FIG. 2, the pressure of the hot gas injected above the glass sheet is increased at t₁, maintained substantially at the same value between t₁ and t₂ and then decreased at t₂ to a value that is identical or not to the initial pressure value before t₁. According to this embodiment, the initial pressure value can be non-zero. In this case, the hot as above the glass sheet is also injected outside the time period between t₁ and t₂ in order to maintain or to restore the flatness of the glass sheet.

According to an additional embodiment of the invention and as illustrated in profile 2 of FIG. 2, the pressure of the hot gas has a peak profile between t₁ and t₂, wherein the upper pressure outside t₁ and t₂ is essentially equal to zero.

According to another additional embodiment of the invention and as illustrated in profile 3 of FIG. 2, the pressure of the hot gas injected above the glass sheet increases between t₁ and t₂ to reach a level beyond t₂. The pressure of the hot as injected above the glass sheet preferably increases by at least 5% between t₁ and t₂.

According to an embodiment of the invention the minimum pressure of the hot as injected above the glass sheet is 5 mbar. The minimum pressure is preferably 10 mbar.

According to another embodiment of the invention, the maximum pressure of the hot as injected above the glass sheet is 15 bar. The minimum pressure is preferably 10 bar.

The pressure of the gas is preferably measured at the end of the hot gas supply means or the injectors.

According to a preferred embodiment of the invention the time t₁ that corresponds to the appearance of flames varies from 1 to 20% of the total heating time T. It is more preferred if the time t1 varies from 5 to 13% of the total heating time T.

In a known manner, the injection of a hot gas below the glass sheet is actuated when the thermal balance of the heat supplied to each face of the sheet becomes unfavourable at its lower face and/or when the glass sheet bends convexly above the conveyor. According to a preferred embodiment of the invention, the actuation of the injection of the hot gas below the conveyor can be controlled by a system for detecting the bending of the glass sheet above the conveyor.

Other advantageous details and features with become evident below from the description of the exemplary embodiment of the invention as well as the comparative example according to the prior art.

### Comparative Example 1 (Not in Accordance with the Invention)

A sheet of clear glass having a coating such as an organic material-based paint was subjected to a heating cycle, which is classically used for a sheet coated with an inorganic type of low-e layer, for which the injections of hot gas above and below the glass sheet are controlled to maintain or restore the flatness of said sheet.

The glass sheet according to the present example has a thickness of 4 mm and the dimensions 100 cm×200 cm. It is covered with an enamel coating. This coating corresponds to a polyacrylic resin-based white coloured enamel. This enamel comprises about 25% by weight of organic material and about 75% by weight of glass frit (fillers). This coating has a thickness of 50 microns once deposited on the glass sheet and dried.

This glass sheet is conveyed in a classic double convection heating oven such as that described in the patent EP1 377 529 B1 with a view to subjecting it to a heat treatment prior to a subsequent toughening step. Said oven comprises a conveyor with horizontal rollers and is fitted with electrical resistors arranged above and below the conveyor to establish a temperature in the order of 670° C. in the oven. The oven is also equipped with ramps for supplying injectors with hot air towards the conveyed glass sheet. These ramps are arranged parallel to one another and to the glass sheet and orthogonally in the direction of movement of the sheet in the oven. The number of these ramps is 9 above the conveyor and 5 below. Each upper ramp is separated from the adjacent ramp by a distance of 550 mm and each lower ramp is arranged below every 8th roller of the conveyor. Each of the ramps is fitted with 45 equidistant injectors with an outlet section of 0.7 mm and this section is separated from the glass sheet at a distance of 150 mm. The upper injectors are arranged so that their axis of symmetry is orthogonal to the plane of the upper face of the glass sheet and the lower injectors are arranged so that their axis of symmetry is oblique in relation to the direction of movement of the glass sheets in the oven and that it intersects the plane of the lower face of this sheet at three-quarters of the distance separating the axes of two successive rollers. The supply ramps are formed from a tube with an inside diameter of 50 mm and are themselves each supplied with air by means of a pipe coil 12 mm in length and 5 mm in diameter wound around the ramp. The temperature of the air inside the ramps is therefore maintained at 670° C., wherein the pressure of the air supply of the lower and upper ramps can be regulated separately.

From entry of the glass sheets the upper supply ramps of the injectors are subjected to an air pressure of 6 bar and the lower ramps are not themselves supplied with air.

After being present in the oven for 10 seconds, intense combustion flames of significant size (several tens of centimetres) appear (t₁). They originate at the surface of the glass sheet.

After being present in the oven for 14 seconds, the glass sheet bends convexly above the conveyor. The lower ramps for supplying hot gas to the injectors are then supplied with air at a pressure of 1 bar in order to restore the flatness of said sheet. The heating cycle ends 180 seconds after entry of the sheet into the oven (total time T).

The product obtained at the end of such a heating cycle has a coating comprising a sintered enamel with a completely non-uniform appearance. They have unappealing black marks resulting from a combustion that was too rapid and too intense and uneven over the entire surface of the glass sheet. Consequently, the process known from the prior art and the timing required for actuation of the injectors is not suitable in the case of a glass sheet having an organic material-based coating. While such a process effectively allows combustion of the organic material by the heat, this is not uniform and causes the above-mentioned disadvantages principally as a result of the presence of flames.

Moreover, repeated exposure of the toughening oven to these flames because of the successive passage of numerous glass sheets of this type on the conveyor would certainly cause rapid and irreversible damage to said oven, and this is completely unacceptable.

### Example 2 (in Accordance with the Invention)

Another sheet of clear glass with identical features to the comparative Example 1 is conveyed in the same oven as that described in comparative Example 1.

As soon as the glass sheet enters the heating oven, none of the supply ramps is supplied with air.

After being present in the oven for 10 seconds (t₁), intense combustion flames of significant size (several tens of centimetres) appear. The upper supply ramps of the injectors are subjected from this precise instant to an air pressure of 8 bar and the lower ramps are themselves still not supplied with air.

After 11 seconds (t₂) the flames have completely disappeared and the supply of the upper ramps of the injectors is then cut.

Control of the flatness of the glass sheet then occurs in the classic manner by using the pressures of the lower and upper supply ramps separately.

The heating cycle finishes 180 seconds after entry of the glass sheet into the oven (total time T).

The product obtained at the end of such a heating cycle has a coating of sintered enamel that is of a uniform white colour and with a desired appealing appearance.

It therefore appears evident that the method of the invention that requires a particular timing for actuation of the injectors (in particular the upper injectors) enables a glass sheet having an organic material-based coating to be efficiently toughened and enables a toughened product with a uniform and appealing appearance to be obtained.

Moreover, control of the appearance of flames or at least their size in accordance with the invention advantageously enables the heating tool to be protected from wear.

Finally, the invention provides a technical solution that is simple and economical such that it does not require additional investment (development and/or purchase of new heating ovens), but proposes a novel and inventive adaptation to the use of existing double convection ovens developed for some other technical problem (that of sagging of the glass sheet).

The invention is, of course, not limited to the above exemplary embodiment.

1. A method for heating, comprising:
(i) transporting a glass sheet, comprising an organic material-based coating, by a roller conveyor;
(ii) heating faces of the glass sheet for a time T with a radiation source arranged above and below the sheet; and
(iii) heating the faces of the glass sheet for a given period of time with forced heat convection by injecting a hot gas above and below the glass sheet,
wherein:
the injecting (iii) of the hot gas above the glass sheet occurs at least between t₁ and t₂, wherein t₁ is a time when flames resulting from combustion of an organic material of the organic material-based coating appear and t₂ is a time when the flames disappear; and
the hot gas injected above the glass sheet comprises a combustive.

2. The method of claim 1, wherein a pressure of the hot gas injected above the glass sheet passes through a maximum between t₁ and t₂.

3. The method of claim 2, wherein the pressure of the hot gas injected above the glass sheet increases by at least 5% between t₁ and t₂.

4. The method of claim 1, wherein the hot gas injected above the glass sheet has a temperature higher than 400° C.

5. The method of claim 1, wherein the hot gas injected above the glass sheet comprises air.

6. The method of claim 1, wherein a minimum pressure of the hot gas injected above the glass sheet is 5 mbar.

7. The method of claim 6, wherein the minimum pressure of the hot gas injected above the glass sheet is 10 mbar.

8. The method of claim 1, wherein a maximum pressure of the hot gas injected above the glass sheet is 15 bar.

9. The method of claim 8, wherein the maximum pressure of the hot gas injected above the glass sheet is 10 bar.

10. The method of claim 1, wherein injection of a hot gas below the glass sheet is actuated when the glass sheet bends convexly above the roller conveyor.

11. The method of claim 2, wherein the hot gas injected above the glass sheet has a temperature higher than 400° C.

12. The method of claim 2, wherein the hot gas injected above the glass sheet is air.

13. The method of claim 2, wherein injection of a hot gas below the glass sheet is actuated when the glass sheet bends convexly above the roller conveyor.
